(19) United States
(12) Patent Application Publication
(10) Pub. No.: US 2014/0318473 A1
(43) Pub. Date: Oct. 30, 2014

(54) ELECTRONIC ANIMAL DETERRENCE FOR FEEDING STATIONS

(71) Applicant: Richard L. Cole, Kennesaw, GA (US)

(72) Inventor: Richard L. Cole, Kennesaw, GA (US)

(21) Appl. No.: 13/870,952

(22) Filed: Apr. 25, 2013

(51) Int. Cl. A01K 29/00

(52) U.S. Cl. CPC A01K 29/00
USPC 119/712

(57) ABSTRACT

The present invention relates to a device for deterring pest animals from reaching and feeding from a feeding station, whereby the feeding station is on a pole, suspended from a hanger, or suspended from a wire. The present invention is placed on the pole, hanger, or wire in a location that prevents the pest animal from getting to the feeding station. The present device provides an electric shock when the pest animal attempts to cross over the present invention.

### BACKGROUND

1. Field of the Invention

This invention relates to a system, method, and device that prevents pest animals from eating from feeding stations intended for birds or other non pest animals by using a safe electric shock as deterrence.

2. Related Art

The following patents are reference material for the invention disclosed in this document: U.S. Pat. No. 4,031,856 (Chester) for an electronic bird feeder and baffle, U.S. Pat. No. 5,191,857 (Boaz) for an electronic bird feeder and baffle, U.S. Pat. No. 5,392,732 (Fry) for a squirrel proof bird feeder, U.S. Pat. No. 5,864,292 (Roestenberg et al.) for an animal electric shock guard, U.S. Pat. No. 5,878,537 (Flischel) for a squirrel proof post, U.S. Pat. No. 6,119,627 (Banyas et al.) for a rodent repelling bird feeder, U.S. Pat. No. 6,125,595 (Showalter) for an insulated electrical shock tube, U.S. Pat. No. 6,158,385 (Boyd) for a bird feeder with electronic squirrel deterrence, U.S. Pat. No. 6,276,298 (Welsh) for a solar powered feeder, U.S. Pat. No. 6,378,459 (Potente) for a method of deterring climbing animals from accessing elevated bird feeders, nesting boxes and plants, U.S. Pat. No. 7,044,085 (Arnold) for a nuisance animal controller, and U.S. Pat. No. 7,574,976 (Ellen et al.) for a bird feeder post and device to inhibit squirrels.

In general, many devices have been used to prevent rodents and other animals from feeding from a feeding station devoted to non-pest animals. Early devices were strictly mechanical in nature. Often these mechanical deterrent systems have to be big and bulky to prevent the pest animal from reaching a feeding station. Later devices did incorporate electrical shock deterrence as an effective method to prevent pests from reaching a feeding station. Several of these electrical shock devices are located directly on the feeding station, while others are located proximal to the feeding station. Of the latter, two specifically are pertinent in relevance to the present invention; they are U.S. Pat. No. 6,125,595 (Showalter), and U.S. Pat. No. 5,392,732 (Fry). Fry describes a device that requires an electrically conductive pole so that the squirrel has to contact the pole and an electrified ring placed onto the pole; whereas, Showalter has a tube that is placed onto a pole and plugged directly into an electrical outlet.

The current invention also uses electrical shock as a deterrent method in a small, safe baffle device. The device uses small voltage electrical power sources to generate a safe high voltage, low amperage shock. A human or animal that receives an electric shock from this device is startled but not harmed. Furthermore, the present invention is energy efficient in that there is very little charge leakage to the ground or air which is present in the previous devices. Lastly, the present invention has the ability to be fitted to various pole sizes and can be easily mass manufactured.

### SUMMARY

According to a broad aspect of the present invention, there is provided a baffle device that uses electric shock generated from a self-contained power source, in which the device is electrically insulated from the support to which it is attached, and in which the pest animal is shocked by closing an open electrical circuit upon climbing the baffle device.

### BRIEF DESCRIPTION OF THE DRAWINGS

The invention will be described in conjunction with the accompanying drawings, in which:

FIG. 1 shows the relative arrangement of the feeding station (4) (a platform type of station) which is supported by the spacing member (2), a rigid pole as the spacing member, the present invention as the animal deterrent baffle (3) placed around a section of the spacing member, and the ground (1) in which the spacing member is set.

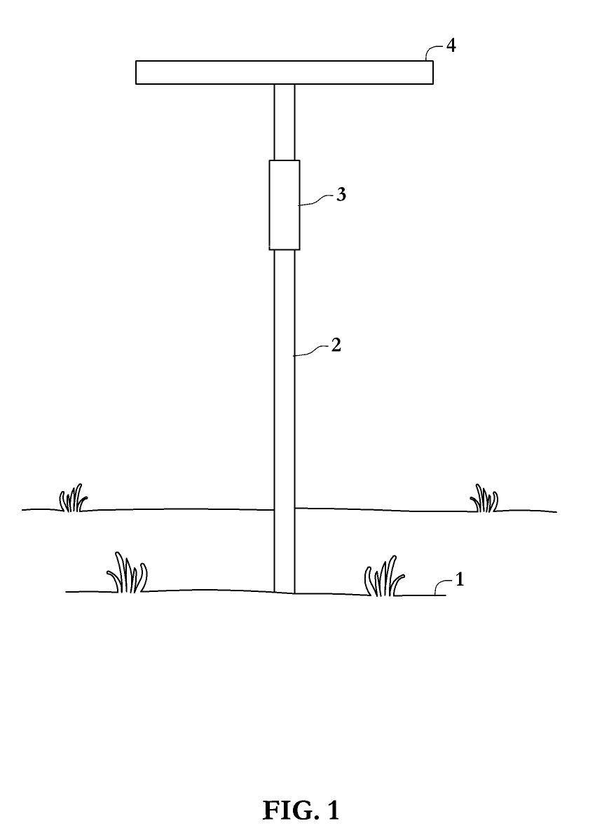

FIG. 2 shows the relative arrangement of the feeding station (4) (tubular feeder type), the animal deterrent baffle (3), the spacing member (2) (rigid hanger type), the spacing members support (5) (an exterior wall or deck in this example), and the ground (1).

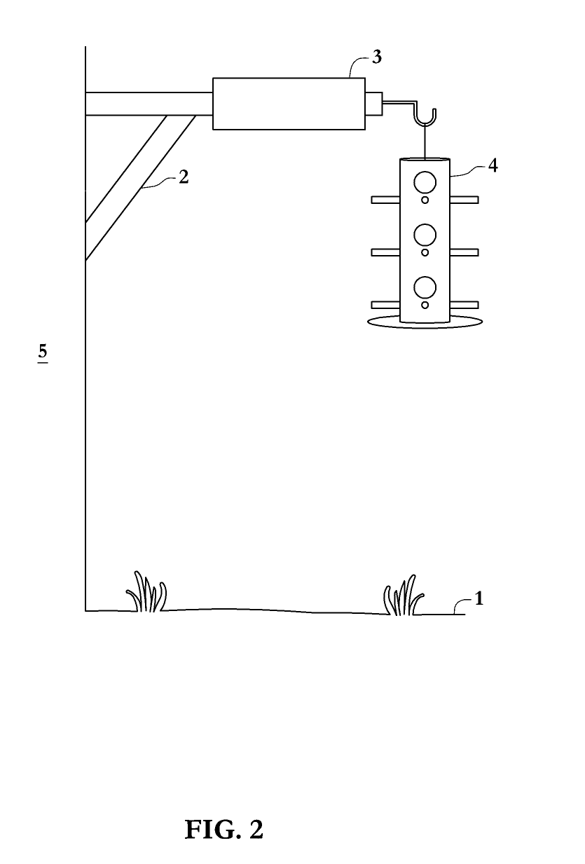

FIG. 3 shows the relative arrangement of the feeding station (4) (a shelter type feeder), the animal deterrent baffle (3), the spacing member (2) (a combination of wire and a rigid metal S hook), and the ground (1).

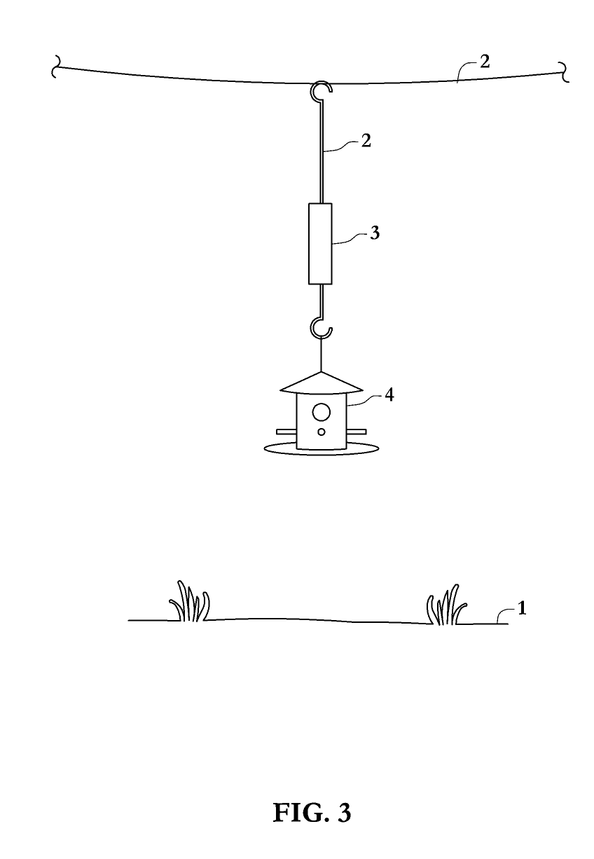

FIG. 4 is a 2 dimensional flat projection of the present invention. When edge 6 is joined with edge 7, a tube is formed. Section 8 and section 9 are the conductive members adhered to the outer surface of the insulative member (10). Section 8 is of one electrical polarity while section 9 is of the opposite electrical polarity. The power unit (11) contains the power source and the circuitry that connects to the conductive members.

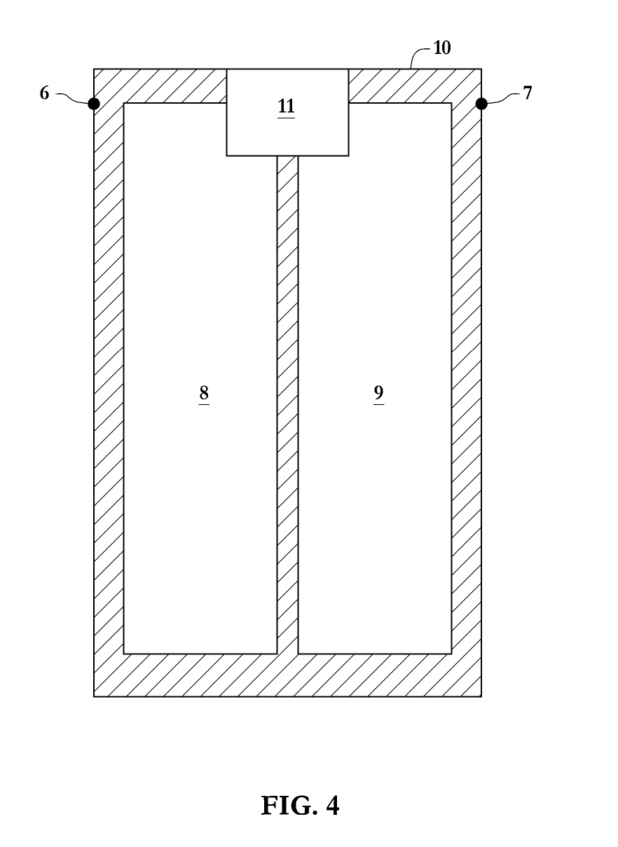

FIG. 5 is a cross sectional view through the present invention (perpendicular to the long axis of the tube). Edges 6 and 7 from FIG. 4 are shown joined together to form the tube shape out of the insulative member material (10). The conductive members (8 and 9) are adhered to the outside surface of the insulative member (10). The power unit (11) has electrical connections to both conductive members (8 and 9).

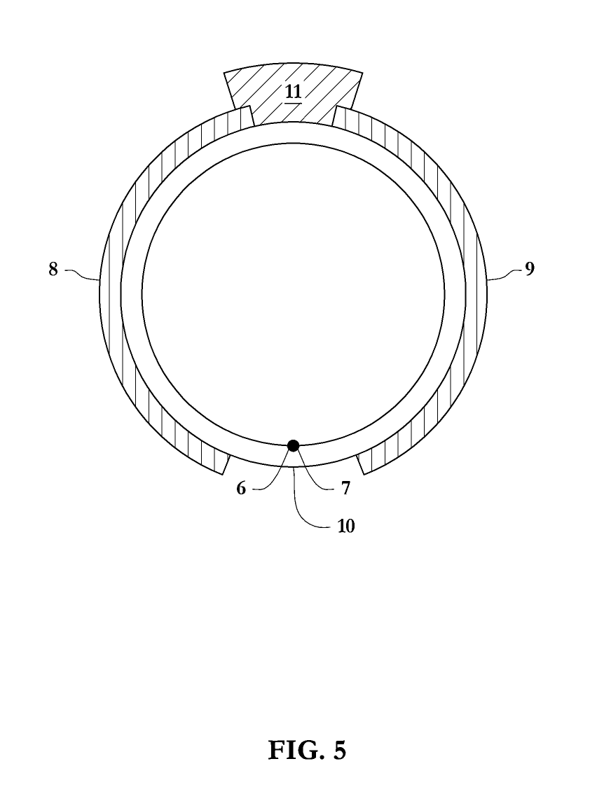

FIG. 6 shows a 2 dimensional flat projection of the present invention showing an embodiment comprising a plurality of wires as the conductive members arranged along the long direction of the tube. The conductive members are adhered to the outer surface of the insulative member (10) which forms a tube when edges 6 and 7 are joined together. The power unit (11) has connections to both sets of conductive members (wire grid of conducting member 8 and wire grid of conducting member 9).

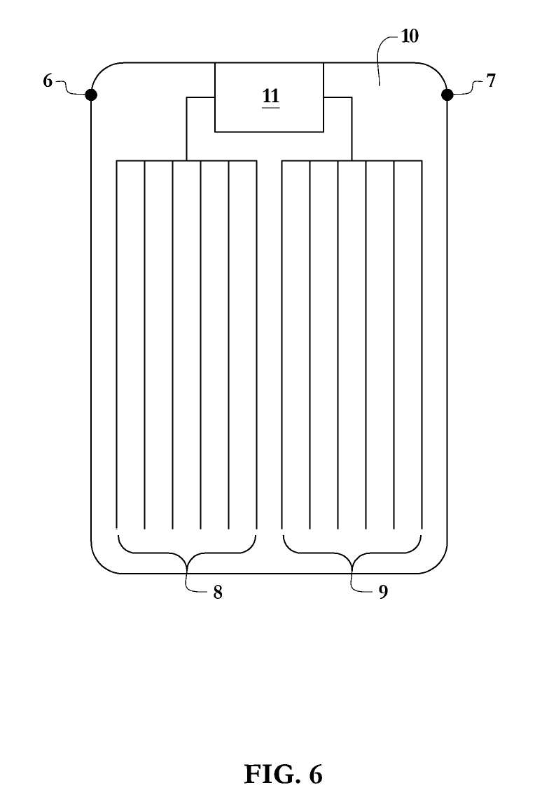

FIG. 7 shows a similar embodiment of the present invention as FIG. 6, but with the wire grids of the conductive members 8 and 9 intermeshed with one another but are not connected to one another. This pattern for the conductive members is preferred in the wrap embodiment. The long dimension of the wrap as wrapped around the spacing member (such as a tree) and can overlap with itself without losing effectiveness or electrically shorting. Additionally, the wrap can be cut to a small size as still function so long as it is long enough to overlap with itself. Also shown are the power unit (11) and the insulative member (10).

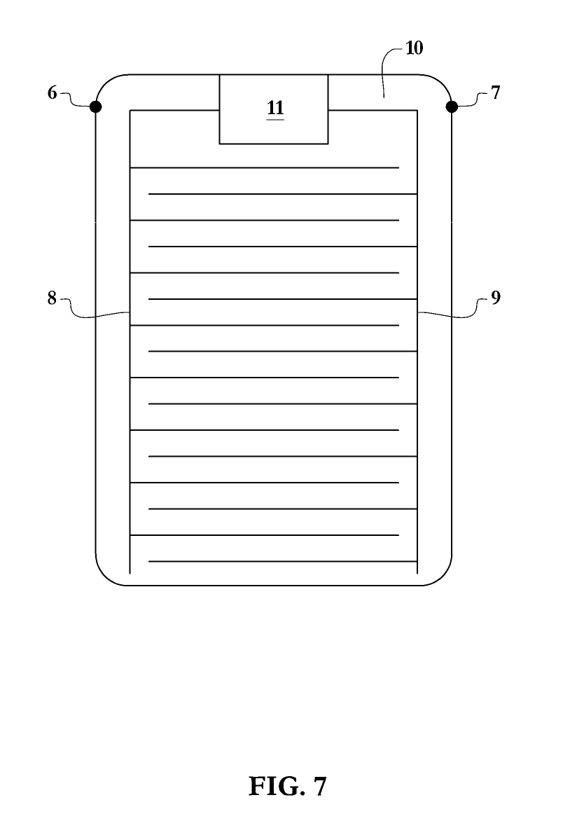

FIG. 8 shows a 3 D rendering of the clamshell embodiment for the animal deterrent baffle. Edges 6 and 7 are joined together to form the tube. The hinges (15) allow for easy opening and closing of the tube. The latch (13) connects with its counterpart (14) to hold the clamshell closed when the edges 6 and 7 are brought together. The power unit (11) is attached to one of the halves of the clamshell. The foam inserts (12) are on the inside surface of the tube. They allow for spacing members of a smaller diameter than the tube diameter to be used and the animal deterrent baffle will still hold onto the spacing member.

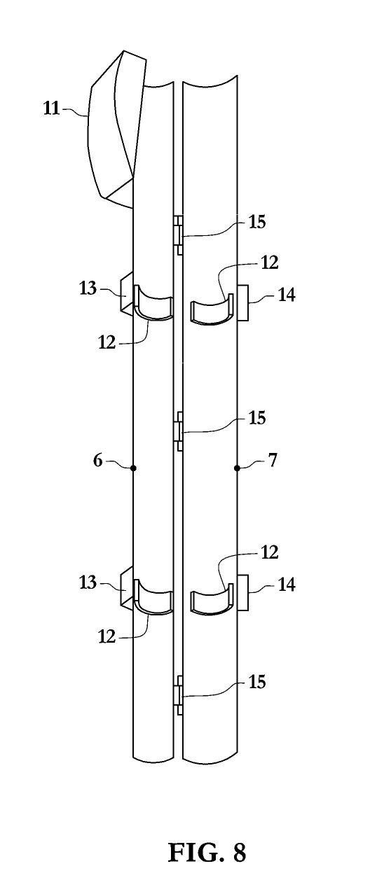

FIG. 9 shows a cone shaped baffle (18) placed on the top portion of the animal deterrent device. The spacing member (2) runs through the center of the animal deterrent baffle. The power unit (11) is shielded from rain, feed, and other debris by the cone shaped baffle (18). The hinges (15) and the conductive members (16) are also shown. The latch (17) holds the tube closed around the spacing member.

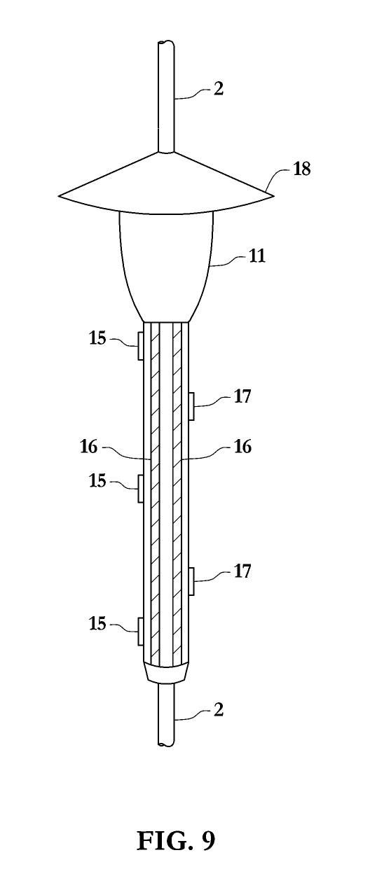

### DETAILED DESCRIPTION

It is advantageous to define several terms before describing the invention. It should be appreciated that the following definitions are used throughout this application.

### Definitions

Where the definition of terms departs from the commonly used meaning of the term, applicant intends to utilize the definitions provided below, unless specifically indicated.

For the purposes of the present invention, the term “pest” is any animal considered as a pest by the user of the animal deterrent device, system, method. Not to be limited by the following examples, typical pest are mice, rats, chipmunks, squirrels, raccoons, opossums, and snakes.

For the purposes of the present invention, the term “feeding station” is any container used to hold food for non-pest animals. Examples include but are not limited to, feeding troughs used for horses, bird feeders for birds, feeding platforms for dogs, etc. . . . In the preferred embodiment of the present invention, the feeding station is for birds and may be any type of bird feeder. Not being limited to the following examples, some typical bird feeders are platform feeders, tubular feeders, shelter feeders, suet feeders, seed cakes, hummingbird feeders, etc. . . .

For the purposes of the present invention, the term “power source” is anything that provides electricity to the device. In the inventions preferred embodiment, the power source is located on the baffle. Examples include batteries, a solar cell, a wind generator, a capacitor, etc. . . . The power source is sometimes referred to as the input power. The input power is typically a low voltage power source that is stepped up into a high voltage in the power unit.

For the purposes of the present invention, the term “power unit” comprises the electronics needed to convert the power source into an output voltage for the deterrent baffle device. The output voltage is supplied to the conductive members. The output voltage is the voltage and amperage needed to power the conductive members such that they are capable of deterring a pest animal from crossing the deterrent baffle device. In addition to the electronics, the power unit comprises the container that contains the electronics for voltage transformations and may sometimes also encase the power source. The power unit may also comprise a sensing circuit.

For the purposes of the present invention, the term “sensing circuit” is anything used to sense the presence of a pest animal. Examples of types of sensing that can be used, but are not limited to, are force sensors, charge sensors, impedance sensors, magnetic sensors, vibration sensors, and light sensors. The sensor is preferably operated with very low voltage and low amperage so as to conserve power from the power source. Once a sensing circuit is triggered, the power unit charges the conductive members with high voltage.

For the purposes of the present invention, the term “spacing member” is anything that supports the feeding station off of the ground or other support. Not to be limited by the following examples of supports; some common supports for the spacing member are the ground, trees, windows, exterior walls, and decks. Some examples of spacing members are poles, post, pipes, wires, ropes, and hangers. Long S-hooks or other shapes of hooking pieces can also be considered as spacing members. In the case of ropes, wires, strings, cables, and similar materials, the spacing member is flexible. In other forms, the spacing member may be flexible, rigid, or both. Poles, posts, pipes, and hangers tend to be rigid. The spacing member will have a long direction that will typically be longer than the diameter. In preferred embodiments of this invention, the diameter for round shaped poles, rods, and pipes, can range from ¼ inch to 2 inches; however larger diameters are also possible. If the spacing member is a rope, string, wire, cable, etc . . . , the diameter of the spacing member will tend to be less than a ¼ inch. The spacing member can be made from any material that is capable of supporting the weight of the feeding station and any animals that may sit on or interact with the feeding station (wood, metal and plastic are the most common materials used).

For the purposes of the present invention, the term “conductive members” are wires or strips of electrically conductive material. The conductive member will usually be made of metals such as copper or aluminum, but other materials are also possible such as graphite.

For the purposes of the present invention, the term “insulative member” of the device separates the conductive members (and sometimes the power source) from the spacing member. It is preferentially nonconductive to electrical charge. The insulative member may be comprised of multiple parts, all of which serve to insulate the conductive members from the spacing member. Some typical materials used for constructing the insulative member are polymers such as, but not limited to, polypropylene, polyethylene, polycarbonate, and poly acrylates.

For the purposes of the present invention, the term “wrap” refers to the insulative member's general shape and application mode. A wrap will have a sheet like appearance and when placed onto a spacing member, it will typically and preferably have some portion of the sheet overlap itself on the spacing member and will have a spiral shape when viewed edge on from the top or bottom of the tube.

For the purposes of the present invention, the term “clamshell” refers one possible embodiment to the insulative member shape. It also refers to a general shape for a container that houses the power unit or power source. A clamshell design for this invention refers to a two sided material preferably with a hinge connecting the two sides, and typically a locking mechanism opposite to the hinged side that is capable of fastening the two sides together when the locking mechanism is engaged. The two sides are concave towards one another to form a hollow area between the sides. The various possible shapes are tubes, boxes, elongated ovals, sphere, etc . . . In the clamshell embodiment for the insulative member, the shape will preferably be a tube with the hinge along the long direction of the tube, such that the tube shape is formed when the locking member connects the two sides. For the power unit, a clamshell preferably forms a fully enclosed volume to protect the electronics and sometimes the power supply from the weather, animals, insects, and dirt.

For the purposes of the present invention, the term “non-pest animal” is referring to animals that the device user is trying to feed; it may be a domesticated, a pet, or a wild animal. For the present invention, the most preferred non-pest animal is a bird. In other embodiments of the present invention, the non-pest animal may be a domesticated animal such as a horse.

For the purposes of the present invention, the terms “adhered”, “adhesive”, and “adhesion” refer to the use of glues, sticky substances, or matched surfaces that cause one part to hold to another part. The adhesion may be permanent, temporary, or reversible. Velcro type materials would be an example of a reversible adhesive. Epoxies or direct welding are examples of a permanent adhesive. Weak adhesives such as used on 3M Post It Notes are an example of a temporary adhesive.

### Description

The present invention covers the area of animal and bird feeding. The invention allows desired animals to feed while pest animals are deterred from accessing the feed station by an electrical shock. The electrical shock is provided by a power unit that produces a safe electrical shock from a variety of potential electrical power sources.

The deterrent device consists of the following members: conductive members, insulative members, and power unit.

The insulative member is generally described by the following: The insulative member attaches to the spacing member. This attachment may be permanent or reversible. The attachment may be mechanical in nature, such as (but not limited to) the use of one or more thumb screws or similar locking mechanisms, or just the friction created by compressing a pliable material onto the spacing member. The attachment of the insulative member to the spacing member can also be accomplished with adhesives. The insulative member may be constructed from or contain a soft pliable material capable of conforming to the contours of the spacing member. The insulative member may also be made from or contain a hard non-pliable material. The insulative member may be a single part or it may be constructed with multiple parts. The insulative member can be made from a single material or combinations of materials as long as it functions to hold the deterrent device in place on the spacing member, prevent the conductive members from electrically shorting to the spacing member or shorting to other parts of the conductive members. The insulative members may be of any color or have any aesthetic design upon its surface. Connected to, adhered to, or embedded into the outside surface of the insulative member are the conductive members. The power unit may be optionally attached (reversibly or permanently) to the insulative member.

In one embodiment of the present invention, the insulative member is a baffle shape. In such a configuration, the supporting member has to be inserted into the center of the baffle from one of the ends of the spacing member. More preferable is either a wrap or clamshell configuration which allows for the placement of the device onto the spacing member from the side (rather than threading from the top or bottom of the spacing member through the hole in the center of the device).

In one embodiment, the insulative member is a wrap. The wrap embodiment allows one to apply the wrap to the spacing member by simply wrapping the spacing member with the insulative member. Preferably, the wrap is long enough to completely surround the spacing member and overlap itself. Hooks, fasteners, or adhesive can optionally be used to keep the wrap overlapped with itself. The insulative member may also be constructed such that it is one long continuous sheet that can be cut to a desired length so as to fit a desired diameter of spacing member. Additionally, the insulative member may be constructed such that two or more insulative sheets may be connected to each other to form a longer sheet so as to fit larger diameters of spacing members.

In a preferred embodiment, the insulative member is a clamshell. The insulative member is a combination of hard and soft portions whereby the soft pliable portion is located adjacent to and in contact with the spacing member and the hard portion surrounds the soft portion (which surrounds the spacing member). This combination essentially forms a soft inner material that grips the spacing member and a hard outer shell upon which the conductive members are adhered. The soft pliable material may be composed of foams (open cell or closed cell foams, or some combination thereof), rubber, wood (preferably cork or balsam), or other pliable material. The soft pliable material may optionally contain an adhesive to allow for better attachment of the insulative member to the spacing member.

The conductive members, in most embodiments, contain at least two conductive wires, sheets, or strips (at least one of each polarity). Preferably, the conductive members will be arranged parallel to one another, though other more complex designs are possible. The conductive members (in the main preferred embodiment) are parallel with one another and are arranged vertically or horizontally in relation to the ground. In other embodiments, diagonal or more complex patterns are possible. The conductive sheets, strips, or wires are arranged and connected in such a manner as to create in an open circuit. The circuit will be closed when a pest animal tries to cross the deterrent device; specifically, the circuit is closed by conduction through the animal's feet, hands, tail, head, body or some combination thereof. The closing of the electrical circuit through the pest animal preferably produces an unpleasant but harmless shock. The conductive wires, sheets, or strips are located either on the surface of the insulative member or recessed into the insulative member. In both cases, the placement of the conductive members allows for the closing of the circuit through the pest animal as it comes into contact with the conductive members of opposite polarity. The conductive members may be adhered to the surface of the insulative member in a permanent way or in a reversible way. The conductive members may have a protective surface coating (to protect them from weathering and rain) so long as the device still works. An example of a protective surface for aluminum is anodized aluminum. Other possible protective coatings may be paint, enamel, a thin layer of plastic, or metal oxides. The conductive members are connected to the power unit (permanently or reversibly).

The power unit is connected electrically to the conductive members. The connection may be permanent or reversible. In one embodiment, the whole power unit comprises a clamshell type case; inside the case may be a power source. In such an embodiment, the power unit or the power source can be selectively detached from the insulative members and/or the conductive members. In some embodiments, the power source is outside the power unit—for example a preferably attached windmill or a preferably attached solar cell. The power unit will preferably be housed in a case to protect the electrical elements from coming into contact with water, dirt, insects, people, and animals. The power unit will optionally have a switch that allows one using the device to turn the device on or off. The power unit will optionally also contain a voltage selector for controlling the output voltage. The power unit should generate a deterrent voltage to the conductive members of greater than 10 volts; more preferably of greater than 1000 volts; most preferably in the range of 2000 to 6000 volts. Even higher voltages can be used if needed depending on the pest animal being deterred. The amperage should be less than 1 amp, and preferably less than 100 mA, and more preferably less than 10 mA. The output voltage can be alternating or direct current. The power source can be direct or alternating current. Preferably, the power unit is powered by the following power sources: batteries, wind generated electricity, solar generated electricity, a piezoelectric crystal, an electrical capacitor, or some combination thereof. If the power source is a battery, one or more 9 volt batteries are preferred. Rechargeable batteries are more preferred. Most preferred is a solar cell connected with a rechargeable battery or capacitor.

In a most preferred embodiment, the power unit contains mechanism for conserving electrical energy such as circuits that sense the presence of a pest animal before charging the conductive members with a full deterrent voltage and/or amperage. Such sensing circuits generally use a small voltage (preferably less than 1 volt, more preferably less than 0.1 volts). One simple sensing circuit comprises a low voltage charge on the conductive members and a logic circuit that triggers the power unit to deliver a high voltage when the circuit of the conductive members is closed. Other types of sensing include, but are not limited to, use of changes in capacitance of the conductive members, the use of force gages, the use of contact switches, the use of pressure switches, or the blocking of a light beam. Other sensing circuits are also envisioned, and all such sensing circuits are used to preserve the electrical energy provided by the power source.

The location of the pest deterrent device on the spacing member is important. The Spacing member (if coming from the ground or deck railing) should be more than 4 feet in length if one is trying to prevent squirrels from reaching the feeding station. If only mice or rodents are the pest animal, then the spacing member should be 1.5 feet or longer. If the pest animal is a raccoon, the spacing member should be greater than 3 feet long. If the pest animal is a bear, the spacing member should be greater than 5 feet long. If the spacing member is a rope or similar type of flexible spacing member, then one will still want the feeding station to be at least the distances above the ground stated above. Additionally, for optimal performance, the feeding station should be at horizontal distances greater than the amount stated above from any nearby objects such as trees or sides of houses to prevent the pest from jumping to the feeder from such nearby objects. In relation to the feeding station, the deterrent device should be placed as close to the feeding station as possible.

In another embodiment, the present invention may have an additional baffle placed above the baffle device of the present invention. The additional baffle would be in a shape that prevents seeds, rain, or debris from contacting the baffle device of the present invention. Example shapes are flat discs, thin cones, or domes.

In an alternative embodiment, the feeding station may be replaced with a nesting station. Examples of nesting stations are structures that animals (in particular, birds) use to build a nest or use the structure as a nest for raising its young. Further example, it is desirable to protect bird houses from animals such as raccoons and other predators. The electronic deterrent device can prevent such predators from reaching the bird house and eating the eggs.

All documents, patents, journal articles and other materials cited in the present application are hereby incorporated by reference.

Although the present invention has been fully described in conjunction with several embodiments thereof with reference to the accompanying drawings, it is to be understood that various changes and modifications may be apparent to those skilled in the art. Such changes and modifications are to be understood as included within the scope of the present invention as defined by the appended claims, unless they depart therefrom.

What is claimed is:

1. An electric deterrent device to prevent animals from accessing a feeding station attached to a spacing member, whereby said electrical deterrent device comprises:
an open electrical circuit powered by a voltage strong enough to deter pest animals from getting to the feeding station,
an insulative member which is located on the spacing member,
at least two conductive members located on the insulative member, as part of the said electrical circuit, arranged such that contact with a pest animal closes the electrical circuit,
and the said deterrent system is powered by an electrical power unit.

2. The invention in claim 1, whereby the feeding station is located on a spacing member and the insulative member is attached to said spacing member, whereby the said spacing member is a pole.

3. The invention of claim 1, whereby the power source is a battery.

4. The invention of claim 1, whereby the power source is a solar panel.

5. The invention of claim 1, whereby the power unit provides greater than 1000 V to the conducting members as the voltage strong enough to deter pest animals.

6. The invention of claim 1, whereby the power unit contains sensing circuits to reduce power consumption of the device.

7. The invention of claim 1, whereby the said animals are members of the rodent family.

8. The invention of claim 1, whereby the feeding station is for birds.

9. The invention of claim 1, whereby the conductive members are wires.

10. The invention of claim 1, whereby the conductive members are flat sheets.

11. The invention of claim 1, whereby the conductive members are arranged vertically on the insulative member.

12. The invention of claim 1, whereby the insulative member is reversibly attachable to the spacer member.

13. The invention of claim 1, whereby the insulative member is composed of a hard section and a soft section, wherein the soft section can conform to the shape of the spacing member.

14. The invention of claim 1, whereby the conductive members are covered in a thin protective coating that protects the conductive members from the weather but yet still allows for the conductive member to deliver an electrical impulse to an animal touching at least two oppositely polarized conductive members.

15. The invention of claim 1, whereby the said deterrent device can fit a range of diameters for the spacing unit.

16. As in claim 15, whereby the insulative member with attached conductive member is a continuous sheet that can be cut to the desired size.

17. As in claim 15, whereby the insulative member with attached conductive member is comprised of one or more sheets that can attach to one another to extend the length of the plurality of sheets, giving the ability to go around larger diameter objects than what a single sheet could fit.

18. As in claim 15, whereby the device can fit ¼ in diameter spacing members to 2 inch diameter spacing members.

19. An electric deterrent device to prevent animals from accessing a bird house attached to a spacing member, whereby said electrical deterrent device comprises:
an open electrical circuit powered by a voltage strong enough to deter pest animals from crossing said electrical circuit,
an insulative member which is located on the spacing member,
at least two conductive members located on the insulative member, as part of the said electrical circuit, arranged such that the animal closes the electrical circuit upon contacting the said device,
and the deterrent system also comprises a power unit.

20. An electric deterrent device comprised of the following:
an open electrical circuit powered by a voltage strong enough to deter pest animals from crossing said electrical circuit,
an insulative member which can be placed on a spacing member,
at least two conductive members located on the insulative member, as part of the said electrical circuit, arranged such that the animal closes the electrical circuit upon contacting the said device,
and the deterrent system also comprises a power unit.
